(19) United States
(12) Patent Application Publication
(10) Pub. No.: US 2009/0134112 A1
(43) Pub. Date: May 28, 2009

(54) BABY BOTTLE WITH CAP ATTACHMENT MEANS

(76) Inventor: April J. Reeves, Cary, NC (US)

Correspondence Address: PASSE' INTELLECTUAL PROPERTY, LLC, 1717 BRASSFIELD RD., RALEIGH, NC, 27614, US

(21) Appl. No.: 11/945,577

(22) Filed: Nov. 27, 2007

(51) Int. Cl. A61J 9/08; A61J 9/00; B65D 55/16

(52) U.S. Cl. 215/11.6; 215/11.1; 215/306

(57) ABSTRACT

The present invention is a baby bottle with a tethered cap. In order to keep the cap from flopping around during bottle use, there is also a means for attaching the cap to the side of the baby bottle.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a means for keeping a tethered baby bottle cap from flopping around during use. In particular the invention relates to an attachment means that can be used to attach a tethered baby bottle cap in the off position.

2. Description of Related Art

Over the years baby bottles have been designed in various shapes sizes colors contours but all have the liquid container portion with the nipple portion at the top of the container. More recently baby bottles include a bottle cap for protecting the nipple from the contamination of the surrounding environment. These covers not only protect the nipple but minimize leakage during transportation and storage while still giving easy access to the nipple for use in feeding baby.

A problem that quickly arose with baby bottle caps is that once removed, it is easy to misplace the cap or have no suitable place to retain the cap during bottle use. A number of solutions have been postulated and introduced to address this situation. For example in US patent application 2005/0109725 there is described a tether for the cap comprising two elastic or other suitable material band like rings connected together via a material to secure them to one another whereby one of the ring shaped elastic members is placed around the baby bottle cap and the other ring shaped elastic member is placed around the baby bottle. In US Patent application 2006/00060553 there is a baby bottle wherein there exists a recess in the bottom of the bottle where the baby bottle cap can be placed and held during use. In yet another attempt to hold the baby bottle cap there is the tether described in U.S. Pat. No. 6,302,286 to Withersoon. The tether connects to the cap and a ring that is placed around the shoulder of the baby bottle. An add on product is shown in U.S. Pat. Design D541,943 to Stewart wherein the baby bottle cap is not directly attached to the tether but is held onto a tether by holding fingers so that the cap can be removed entirely if desired.

While the means in the art that keep the cap attached to the bottle preventing its loss under all circumstances there is a substantial problem with the tether arrangement for a baby bottle cap. In use of the bottle the bottle cap will swing about as the bottle is held and moved about. This occurs and then the cap can strike the baby or otherwise interfere repeatedly with the feeding process. While the recessed placement of the cap solves this problem it does not prevent loss of the cap by separation of the cap from the bottle.

Accordingly it would be useful if there were a bottle cap holder that prevented separation of the cap yet prevented the cap from flailing about during bottle use. It is therefore an object of this invention to overcome the problems and limitations of the currently used bottle cap holders.

### BRIEF SUMMARY OF THE INVENTION

The present invention relates to a baby bottle with a tethered bottle cap that comprises a means for fixing the cap to the bottle during bottle use. The attachment of the cap to the surface of the bottle will prevent movement of the cap during bottle use and prevent the problems and overcome the objections of the prior cap holders.

Accordingly, in one embodiment of the present invention there is a baby bottle with a cap for covering the baby bottle nipple comprising:
a) a tethering means for keeping the cap with the bottle when the cap is removed from covering the nipple; and
b) a means for removably attaching a removed baby bottle cap to a side surface of the baby bottle while the cap is in the removed state.

Another embodiment of the invention is a device for adding to a baby bottle comprising a cap for use with a baby bottle for covering the nipple of the bottle comprising:
a) a tethering means for attaching the cap to the bottle; and
b) a mating means for attaching the cap to a side of the baby bottle.

A number of different embodiments of this invention will be clear from both the drawings and description as contained herein and nothing otherwise is intended to be considered limiting in description unless otherwise so described.

### BRIEF DESCRIPTION OF THE DRAWINGS

FIG. 1 is an embodiment of the present invention showing a nub and clip arrangement of the entire baby bottle of the invention.

FIG. 2a is an embodiment of the present invention showing a hook and loop attachment means.

FIG. 2b is an embodiment of the present invention showing male and female snap attachment means.

FIG. 2c is an embodiment where the cap fits into a recess and it held in place by a friction means.

FIG. 2d is an embodiment where the side of the bottle cap is attached to the bottle.

FIG. 3 is a perspective view of an embodiment of the invention which is designed for adding to a baby bottle.

### DETAILED DESCRIPTION OF THE INVENTION

The present invention relates to the discovery that if a tethered baby bottle cap has a means for attaching the cap to the surface of the bottle during baby bottle use it will overcome the objections and limitations of the prior art. This is especially true that the present invention will not flail about during bottle use yet still be attached to the baby bottle preventing loss or misplacement of the baby bottle cap.

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein a “tethering means” refers to a strap, strip, band, cord, rope string or the like that attaches the cap to the baby bottle. The tether is designed to be long enough to clear the general area around the nipple yet not too long as to leave the cap dangling far away from the bottle or have an unnecessarily long tether. One skilled in the art will be able to determine the correct length. The tether may be attached to the bottle via any convenient means such as attachment ring located on the neck or further up or held by the ring holding the nipple in place. It could also be a removable means where desired and a convenient design will be obvious in view of this disclosure. While in one embodiment the tether is attached to the upper portion of the baby bottle. It could in other embodiments be attached to the bottle in any place as desired. The tether is also attached to the baby bottle cap. The attachment will be on the outside surface of the baby bottle cap such as on the side or on the top as desired. The drawings which follow show the attachment on the top of the cap but could also be on the side as desired.

As used herein the “means for removably attaching the baby bottle cap to a surface of the baby bottle” refers to being able to have a means for the bottle cap to attach to the side of the baby bottle and then removing it, multiple times. The side includes the main body of the baby bottle as well as the sloping neck of the baby bottle in those that are not completely cylindrical of the same diameter for the whole body. This usually means that there are matching attachment means on both the cap and also someplace on the side surface of the bottle.

A number of different attaching means could be contemplated as working within the scope of the present invention. One group of means would be a mating means. A mating means would be where there is a mechanical means on the cap, the bottle or both that mechanically attaches the cap to the bottle. Embodiments of mating means include snaps, hook and loop fasteners (such as Velcro), adhesives (which could be applied to the cap, the bottle or both) and clips. Other mechanical means could of course been envisioned or designed within the contemplation of a mating means.

Another attachment means would be a depression friction means. A depression friction means would consist of a depression at some position on the side of the bottle. A portion of the baby bottle cap would then fit into the depression and by friction stay positioned within the depression.

The present invention also includes a device for adding to an existing baby bottle for fixing the baby bottle cap. The mating means above could be combined and a baby bottle cap, tether and mating means produced for sale for use with a baby bottle. The depression friction means would not be of value since the existing baby bottle would not have an appropriate depression.

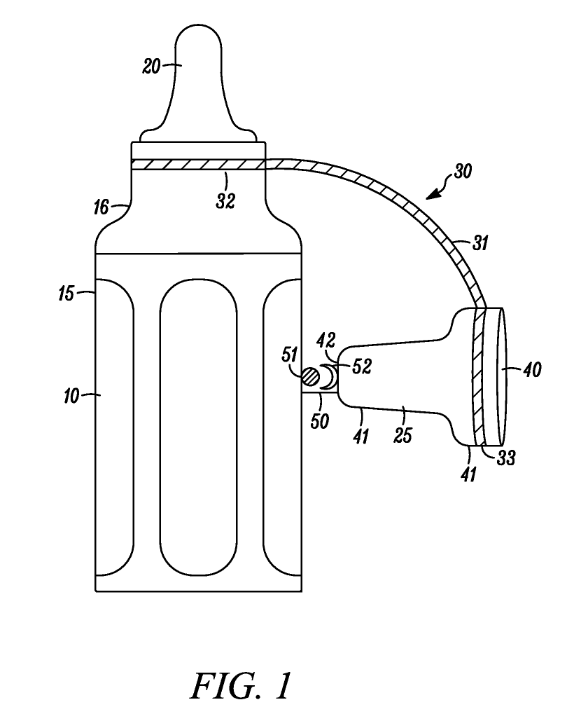

Now referring to the drawings FIG. 1 is an embodiment of the present invention comprising a baby bottle 10. The baby bottle 10 comprises baby bottle side 15 and neck side 16. The baby bottle has nipple 20 and cap 25 which fits over the nipple 20 when nipple 20 is not in use with bottle 10. The cap 25 remains with bottle 10 via use of tether 30. The tether 30 consist of the cord portion 31 the bottle tether attachment 32 and the tether cap attachment 33.

The cap 25 consists of the cap opening 40 which fits over nipple 20 and cap sides 41 and cap top 42. In this embodiment as shown in FIG. 1 the cap 25 has a mating attachment means consisting of a ball 51 and clip 52 which can grab and hold ball 51. By engaging the ball 51 and clip 52 the cap 25 is held in place and can later removably be replaced back over nipple 20 as desired.

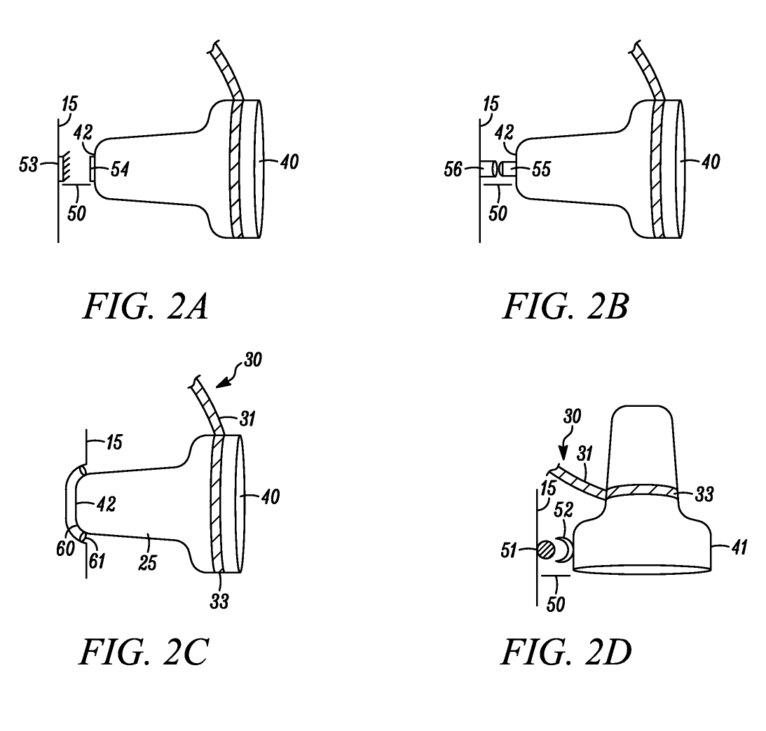

FIGS. 2a, 2b, 2c and 2d show various embodiments of mating and depression friction means for attaching the cap 25 to bottle 10 from FIG. 1. In FIG. 2a, a hook and loop arrangement 53 and 54 are shown for attaching the top 42 of cap to the bottle side 15. Likewise FIG. 2b depicts snap arrangement with male 55 and female 56 snaps.

FIG. 2c depicts the embodiment wherein there is depression 60 in bottle side 15. Shown in this embodiment are friction grabbers 61 for firmly holding cap 25 in place. FIG. 2d shows an alternate embodiment where the cap side 41 is attached to bottle side 15 instead of by cap top 42 as shown in the other embodiments. Again the ball 51 and clip 52 arrangement is shown.

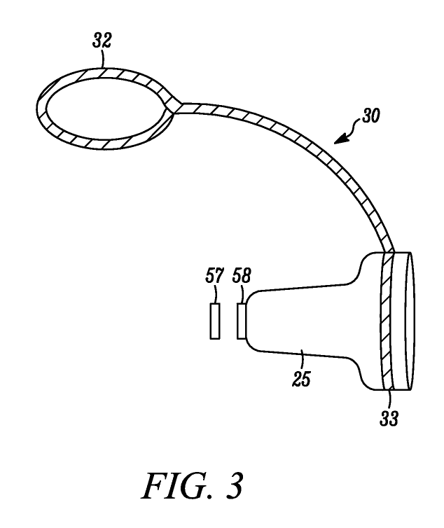

FIG. 3 depicts another embodiment of the invention wherein the cap 25 and tether 30 and attachment means 50 are separate from a bottle and can be added to a bottle as desired. In this embodiment the attachment means 50 is a pair of reusable adhesive pads 57 and 58. The solo pad 57 can be attached to any bottle as desired and then the adhesive 58 on the cap 25 of the invention will stick to the pad 57. In an alternate embodiment pad 57 is done away with and pad 58 is a reusable adhesive which sticks to aside of a baby bottle.

What is claimed is:

1. A baby bottle with a cap for covering the baby bottle nipple comprising:
a) a tethering means for keeping the cap with the bottle when the cap is removed from covering the nipple; and
b) a means for removably attaching a removed baby bottle cap to a side surface of the baby bottle while the cap is in the removed state.

2. A baby bottle according to claim 1 wherein the means for attaching the cap is a mating means.

3. A baby bottle according to claim 1 wherein the mating means is selected from the group consisting of snaps, hook and loop fasteners, adhesives and clips.

4. A baby bottle according to claim 1 wherein the means for attaching the cap is a depression friction means.

5. A baby bottle according to claim 1 wherein the side surface is on the neck of the bottle.

6. A baby bottle according to claim 1 wherein the side surface is the main body of the baby bottle.

7. A cap for use with a baby bottle for covering the nipple of the baby bottle comprising:
a) a tethering means for attaching the cap to the bottle; and
b) a mating means for attaching the cap to a side of the baby bottle.

8. A cap according to claim 7 wherein the mating means is selected from the group consisting of snaps, hook and loop fasteners, adhesives and clips.

9. A cap according to claim 7 wherein the tethering means has a hoop for attaching to a baby bottle.

10. A cap according to claim 7 wherein the tether attaches to a baby bottle cap by use of a loop.
